(19) United States
(12) Patent Application Publication
(10) Pub. No.: US 2020/0325869 A1
(43) Pub. Date: Oct. 15, 2020

(54) Fuel Injector Cup, Fuel Injector Cup Assembly, Fuel Injector Assembly And Methods For Producing The Same

(71) Applicant: Continental Automotive GmbH, Hannover (DE)

(72) Inventors: Marco Pasquali, Livorno (IT); Davide Matteini, Livorno (IT); Andrea Puccini, San Miniato (PI) (IT); Rene Krahn, Pietrasanta (IT); Michael Sicker, Straubing (DE)

(73) Assignee: Continental Automotive GmbH, Hannover (DE)

(21) Appl. No.: 16/305,679

(22) PCT Filed: May 12, 2017
(86) PCT No.: PCT/EP2017/061529

§ 371 Date: Nov. 29, 2018

(30) Foreign Application Priority Data
Jun. 2, 2016 (EP) 16172619.5

(51) Int. Cl. F02M 61/14; F02M 61/16

(52) U.S. Cl. CPC F02M 61/145; F02M 55/025; F02M 61/168

(57) ABSTRACT

Various embodiments may include a fuel injector cup assembly comprising: a fuel injector cup; a fastening bracket for securing a fuel injector to the cup; and a clamping arm for fastening the cup to an engine. The cup has a main body part with an internal volume. The cup comprises a one-piece body defining the main body part and an inlet stub containing a fuel inlet port hydraulically connectable to the fuel source. The stub has a first external dimension. The main body part has a second external dimension larger than the first external dimension to provide a shoulder supporting the clamping arm. An end of the cup remote from the stub has an outwardly extending flange supporting the fastening bracket.

### CROSS-REFERENCE TO RELATED APPLICATIONS

This application is a U.S. National Stage Application of International Application No. PCT/EP2017/061529 filed May 12, 2017, which designates the United States of America, and claims priority to EP Application No. 16172619.5 filed Jun. 2, 2016, the contents of which are hereby incorporated by reference in their entirety.

### TECHNICAL FIELD

The present disclosure relates to internal combustion engines. Various embodiments may include a fuel injector assembly, a fuel injector cup assembly for hydraulically and mechanically coupling a fuel injector to a fuel source, and/or fuel injector assemblies for use with a multi-cylinder direct injection gasoline engine having a fuel injector for each cylinder, the injectors being connected to a fuel source comprising a common rail.

### BACKGROUND

A common rail comprises a fuel reservoir of relatively large volume to which fuel from a fuel tank is pumped under high-pressure. The individual fuel injectors each have a supply pipe for connection to the common rail which is kept as short as possible in order to keep pressure fluctuations during operation to a minimum.

WO 2015/014595 A1 discloses a fluid injection assembly for a combustion engine which comprises a spring clip arranged between an injector body and an injector cup. The spring clip comprises a ground plate and at least one spring element fixedly coupled with the ground plate. The spring element has a contact region with the injector cup and the ground plate has a contact region with the injector body, so that a spring force is exerted by the spring clip on the injector body. The injector body and the injector cup are coupled together by two holding elements, each of the holding elements extending in the direction of the longitudinal axis and engaging behind a fixation element.

EP 2860389 A1 discloses a fuel injector assembly with a fuel injector and a connection device, for connecting the injector to the common rail, comprising a fuel injector cup. The injector cup also ensures that the fuel injector tip position is accurately located to ensure efficient injection. The cup is incorporated in the connection between the common rail and the fuel injector but it is a complex, cost intensive design made by cold forming.

### SUMMARY

The teachings of the present disclosure may be embodied in a simpler, lower cost concept which uses significantly less material, whilst maintaining the necessary precision of location of the injector. For example, some embodiments include a fuel injector cup assembly comprising a fuel injector cup (14), a fastening bracket (30) for securing a fuel injector (6) to the cup (14) and a clamping arm (40) for fastening the cup (14) to an engine (2), the fuel injector cup (14) comprising a main body part (18) having an internal volume (20) adapted to be connected to a fuel source and to receive a fuel inlet end of the fuel injector (6), wherein the cup (14) comprises a one-piece body comprising the main body part (18) and having an inlet stub (22) containing a fuel inlet port (26) hydraulically connectable to the fuel source, the stub (22) having an external dimension, the main body part (18) of the cup (14) having an external dimension larger than the external dimension of the stub (22) to provide an shoulder (24) supporting the clamping arm (40), the end of the cup (14) remote from the stub (22) having an outwardly extending flange (28) supporting the fastening bracket (30).

In some embodiments, the cup (14) is a one-piece body formed from a sheet material, in particular by deep drawing or a pressing technique.

In some embodiments, the fastening bracket (30) and the clamping arm (40) are welded or brazed to the cup (14).

In some embodiments, the fastening bracket (30) has a central bore (32) dimensioned to fit over the main body part (18) so as to sit on the flange (28), the bracket (30) further including two outwardly extending webs (34) each containing an opening (36) adapted to receive a fastening element (38) of the fuel injector assembly by means of which the cup (14) and the fuel injector (6) are secured together.

In some embodiments, the openings (36) in the webs (34) comprise a bore adapted to receive a bolt (38).

In some embodiments, the flange (28) has outwardly extending opposed webs (52) each having a recess (54) extending inwardly from the outer edge of the web (52), the recesses aligning with the openings (36) for the bolts (38).

In some embodiments, the clamping arm (40) has at one end an opening (42) adapted to fit over the stub (22) so as to rest on the shoulder (24), the other end of the arm remote from said one end having an opening (44) through which a securing element is able to fasten the clamping arm (40) to the engine (2) to thereby clamp the assembly (12) to the engine.

In some embodiments, the stub (22) is brazed or welded to a fuel pipe (8) connected hydraulically and mechanically to the fuel source.

In some embodiments, the end of the pipe (8) fits within the fuel inlet port (26).

In some embodiments, a closure device (56, 58, 60) is secured to the outer end of the pipe (8) in the fuel inlet port (26) to close any gap between the pipe (8) and the inner surface of the fuel inlet port (26) to prevent brazing or welding material entering the volume (20).

In some embodiments, the closure device (56, 58, 60) comprises a ring (56), a Belleville washer (58) or an outwardly extending flange (60) secured to the pipe (8).

As another example, some embodiments include a method of producing a fuel injector cup assembly comprising the steps of: forming a main body part (18) and an inlet stub (22) of an injector cup (14), the main body part (18) having an internal volume (20) and the stub (22) containing a fuel delivery port (26) for connecting the volume (20) to a fuel source, the volume (20) being provided for receiving an inlet end of a fuel injector so as to provide a hydraulic communication between the inlet end of the fuel injector and the fuel source, forming the stub (22) with an external dimension smaller than an external dimension of the main body part (18) containing the volume (20), to form a shoulder (24), locating a clamping arm (40) on the shoulder (24), the clamping arm (40) being provided for fastening the cup (14) to an engine (2), providing an outwardly extending flange (28) on the cup (14) at the end remote from the stub (22), and locating a fastening bracket (30) on the flange (28), the fastening bracket (30) being provided for securing the fuel injector (6) to the cup (14) and in particular having outwardly extending webs (34) with openings (36) each adapted to receive a fastening element usable to secure the cup (14) and the injector (6) together.

In some embodiments, forming an injector cup (14) comprises forming the cup (14) as a one-piece body from a sheet material by deep drawing and/or by a pressing technique.

In some embodiments, the method includes spot welding the fastening bracket (30) and/or the clamping arm (40) to the cup (14).

In some embodiments, the stub (22) has an external diameter, the main body part (18) of the cup (14) being cylindrically formed with an external diameter larger than the diameter of the stub (22) to provide the shoulder (24), the shoulder (24) being annularly shaped.

### BRIEF DESCRIPTION OF THE DRAWINGS

Various example embodiments of the fuel injector cup, the fuel injector cup assembly, the fuel injector assembly, and the methods are described by way of example with reference to the accompanying drawings in which:

FIG. 1 shows a schematic perspective view of a system incorporating a fuel injector assembly with a common rail and a fuel injector for each cylinder of a multicylinder internal combustion engine incorporating teachings of the present disclosure;

FIG. 2 shows an exploded view of components of an example fuel injector cup assembly of the fuel injector assembly for securing the injectors in position with respect to the engine incorporating teachings of the present disclosure;

FIG. 3 shows a perspective view of the assembled components of the fuel injector cup assembly of FIG. 2,

FIG. 4 shows a longitudinal section view of an example injector cup of the fuel injector cup assembly incorporating teachings of the present disclosure;

FIG. 5 shows an example injector cup assembly connected to a fuel pipe of the fuel injector assembly leading to the common rail incorporating teachings of the present disclosure;

FIG. 6 shows a bottom view of an example injector cup incorporating teachings of the present disclosure; and

FIGS. 7-12 show alternative methods of securing an injector cup to a fuel pipe.

### DETAILED DESCRIPTION

In some embodiments, a fuel injector cup may be part of a fuel injector assembly for use with a multi-cylinder direct injection gasoline engine having a fuel injector for each cylinder, the injectors in particular being connected to a fuel source comprising a common rail. The common rail may also be denoted as main gallery. In some embodiments, it is an elongated, tubular fuel reservoir for storing fuel under high pressure.

In some embodiments, the fuel injector cup is a fuel injector cup for a fuel injector assembly, the cup comprising a main body part having an internal volume adapted to be connected to a fuel source and to receive a fuel inlet end of a fuel injector. The cup comprises a one-piece body having an inlet stub containing a fuel inlet port hydraulically connectable to the fuel source, the stub having an external dimension. In some embodiments, the one-piece body also comprises the main body part.

In some embodiments, the main body part of the cup has an external diameter larger than the diameter of the stub to provide a shoulder adapted to support a clamping arm, by which the cup is fastened to an engine. The end of the cup remote from the stub has an outwardly extending flange, adapted to support a fastening bracket through which the fuel injector and the cup are secured together. The flange is preferably comprised by the one-piece body.

In the present context, the expression “one-piece body” means the one-piece body is not assembled from a plurality of parts which are connected to one another during the manufacturing process of the cup. Rather, the one-piece body is a single workpiece or made from a single workpiece.

In some embodiments, the fuel injector cup assembly comprises the fuel injector cup, the fastening bracket for securing the fuel injector to the cup and the clamping arm for fastening the cup to the engine. In some embodiments, the shoulder may support the clamping arm and the flange may support the fastening bracket in case of the fuel injector cup assembly. Thus, the fuel injector cup assembly may have a three piece or four piece modular construction consisting of an injector cup, the fastening bracket, the clamping arm, and an optional reinforcement ring further described below.

In some embodiments, the fastening bracket, the clamping arm, and the reinforcement ring may each be individual and separately manufactured parts, different from the fuel injector cup. This arrangement may provide a more compact, lighter weight cup using significantly less material than the known arrangements. The fastening bracket and the clamping arm are also light weight and are preferably formed from a sheet material. In some embodiments, a three piece modular construction is possible by omitting, for example, the reinforcement ring. The three or four components are more efficient to be manufactured than the costly prior art arrangements. In some embodiments, the cup assembly may be modified to fit different engines and injectors by simply changing the fastening bracket and/or clamping arm to fit the new installation.

In some embodiments, the cup is a one-piece body formed from a sheet material, in particular by deep drawing, or by a pressing technique. In this way, the cup can be manufactured in particularly cost-efficient manner. To facilitate assembly, the fastening bracket and the clamping arm may be welded or brazed to the cup. In this way, differently fastening brackets and/or clamping arms can be combined with a standardized cup. In this way, the fuel injector cup assembly may be easily and cost-efficiently adaptable to different engines.

In some embodiments, the fuel injector cup assembly has a fuel injector cup according to above embodiments wherein the fastening bracket has a central bore dimensioned to fit over the—in particular cylindrical—main body part so as to sit on the flange.

In some embodiments, the bracket further includes two radially outwardly extending webs each containing an opening adapted to receive a fastening element by means of which the cup and the fuel injector are secured together. A high mechanical stability of the injector cup assembly—in particular in the region of the flange—is achievable in this way.

In some embodiments, a connection plate is located between the cup and the fuel injector. The connection plate may be rigidly fixed to the bracket by means of the fastening elements and interacts mechanically with the fuel injector—e.g. by a form-fit or forcefit connection with the fuel injector—to prevent displacement of the fuel inlet end of the fuel injector out of the cup. For example, the connection plate may be secured to the fuel injector by means of at least one snap ring.

In this way, the injectors may be suspended in the respective cups. In some embodiments, the fuel injector assembly does not comprise any spring clips which press the fuel injectors against the cylinder head of the engine. Rather, each fuel injector may be spaced apart from the cylinder head, in particular at all places except for a sealing area represented by at least one elastomeric sealing ring extending circumferentially around a valve body of the fuel injector. In some embodiments, a particularly low noise level of the fuel injector assembly and/or the engine is achievable in this way.

In some embodiments, the central bore is a close sliding fit on the main body part, which may reduce the risk of misalignment during assembly.

In some embodiments, the flange has outwardly extending opposed webs each having a recess extending radially inwardly from the outer edge of the web, the recesses aligning with the openings for the bolts.

In some embodiments, the clamping arm has at one end an opening adapted to fit over the stub so as to rest on the shoulder, the other end of the arm remote from said one end having an opening through which a securing element is able to fasten the clamping arm to the engine to thereby clamp the assembly to the engine. This may facilitate accurate alignment of the parts during assembly. This is further enhanced in further embodiments in which the opening is a close sliding fit on the stub.

In some embodiments, the clamping arm comprises a flat plate element defining the opening through which the stub extends and the opening configured to receive the securing element and the reinforcement ring extending around the latter opening. The reinforcement ring may be laterally spaced apart from the opening through which the stub extends. The plate element and the reinforcement ring may comprise metal parts, in particular sheet metal parts. In some embodiments, the reinforcement ring is welded and/or brazed to the plate element.

In this way, the thickness of the clamping arm may be increased only in the region of the opening for the securing element so that a satisfactory mechanical stability, a low weight and low manufacturing costs for the clamping arm are achievable.

In some embodiments, the fuel injector assembly comprises a bolt retainer. The bolt retainer secures the bolt to the clamping arm during transportation and assembly of the fuel injector assembly. The bolt retainer may comprise plastic and/or an elastomeric material such as rubber. Due to the larger thickness achieved by means of the reinforcement ring, a bolt retainer can be secured particularly well to the clamping arm.

In some embodiments, the stub is brazed or welded to a fuel pipe connected hydraulically and mechanically to the fuel source.

In some embodiments, the end of the pipe fits within the fuel inlet port of the fuel injector cup, and a closure device is secured to the outer end of the pipe in the fuel inlet port to close any gap between the pipe and the inner surface of the fuel inlet port, in particular so as to prevent brazing or welding material entering the volume sealing the area of the fuel injector. The risk of producing malfunctional fuel injector assemblies may be particularly small in this way. The closure device may comprise a ring, a Belleville washer, and/or an outwardly extending flange secured to the pipe.

In an example method for producing the fuel injector assembly, the end of the pipe remote from the closure device may be shifted through the internal volume and the fuel inlet port for assembling the pipe and the cup, in particular until the closure device comes in mechanical contact with the cup.

In some embodiments, for a multi cylinder internal combustion engine, the fuel source comprises a common rail, to which a fuel injector for each cylinder is attached. The fuel injectors comprise direct gasoline fuel injectors in one development.

In some embodiments, the fastening bracket has a central bore dimensioned to be a close sliding fit on the cylindrical main body part so as to sit on the flange, the bracket further including two radially outwardly extending webs each containing an opening adapted to receive a fastening element by means of which the cup and the fuel injector are secured together.

The openings in the webs may comprise a bore adapted to receive a bolt, or may each comprise a recess extending radially inwardly from the outer edge of the web. This provides an economically effective and simple way of securing the cup and the fuel injector together by using simple components which do not need expensive tooling to produce.

In some embodiments, the clamping arm has at one end an opening adapted to fit over the stub with a close sliding fit so as to rest on the shoulder. The other end of the arm remote from said one end has an opening through which a securing element is able to fasten the clamping arm to the engine to thereby clamp the assembly to the engine. This provides an economically effective solution which does not need expensive tooling to produce. In some embodiments, the securing element is a bolt.

An example method of producing a fuel injector cup assembly comprises the steps of forming an injector cup having an internal volume and a stub containing a fuel delivery port for connecting the volume to a fuel source. In some embodiments, forming the injector cup may comprise forming a main body part and the inlet stub of the injector cup, the main body part having the internal volume. The volume is shaped and arranged for receiving an inlet end of a fuel injector so as to provide a hydraulic communication between the inlet end of the fuel injector and the fuel source. In the method, the stub is formed with an external diameter smaller than the diameter of the part containing the volume, to form an annular shoulder. In some embodiments, the method may comprise a step of locating a clamping arm on the shoulder, the clamping arm (40) shaped and arranged for fastening the cup to an engine.

In some embodiments, the stub has an external diameter, the main body part of the cup being cylindrically formed with an external diameter larger than the diameter of the stub to provide the shoulder. The shoulder may be annularly shaped.

In some embodiments, the method comprises a step of providing a radially outwardly extending flange on the cup at the end remote from the stub and locating a fastening bracket on the flange. The fastening bracket is shaped and arranged for securing the fuel injector to the cup. In some embodiments, the fastening bracket has outwardly extending webs with openings adapted to receive a fastening element usable to secure the cup and the injector together.

In some embodiments, the method further comprises a step of securing a fuel feed pipe to the stub to enable the cup to be secured to the fuel source.

In some embodiments, a method of producing a fuel injector assembly may comprise the method for producing the fuel injector cup assembly. In some embodiments, the method comprises steps of securing an inlet end of a fuel injector in the volume so as to provide a hydraulic path between the inlet end of the fuel injector and the fuel source and of using the fastening elements to secure the cup and the injector together.

In some embodiments, the method step for forming an injector cup comprises forming the cup as a one-piece body from a sheet material, in particular by deep drawing and/or by a pressing technique. In some embodiments, the fastening bracket and/or the clamping arm is/are spot welded to the cup.

In some embodiments, the method comprises locating a clamping arm on the shoulder, clamping arm being configured and arrangeable to fasten the cup to an engine. In one development, the method comprises spot welding the clamping arm to the cup.

In some embodiments, there is a method for producing a fuel injector cup for a fuel injector assembly, the cup comprising a main body part having an internal volume adapted to be connected to a fuel source and to receive a fuel inlet end of a fuel injector, the method comprising forming the cup as a one-piece body from a sheet material to provide a tubular inlet stub containing a fuel inlet port hydraulically connectable to the fuel source, the stub having an external diameter, the main body part of the cup being cylindrically formed with an external diameter larger than the diameter of the stub to provide an annular shoulder adapted to support a clamping arm, by which the cup is fastened to an engine, the end of the cup remote from the stub being formed with a radially outwardly extending flange, adapted to support a fastening bracket through which the fuel injector and the cup are secured together.

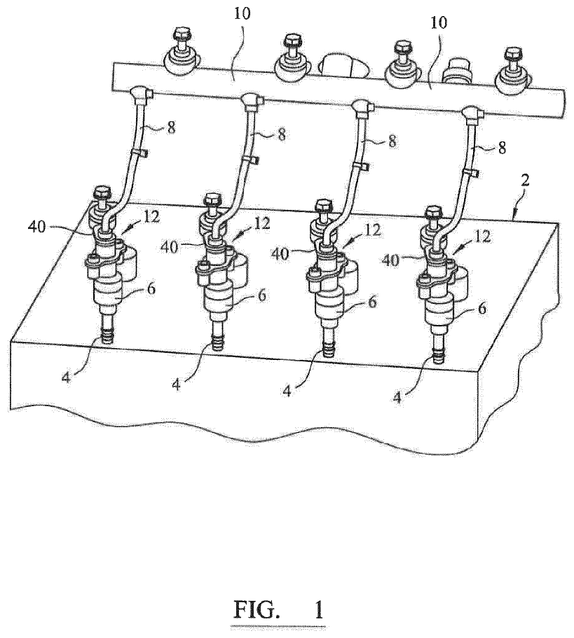

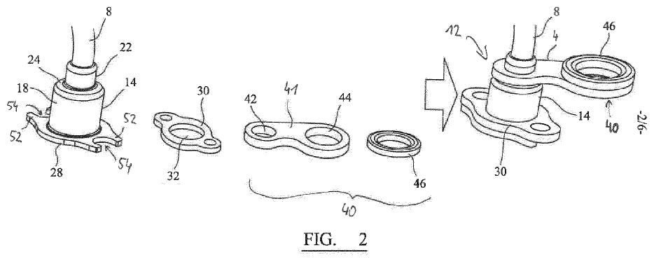

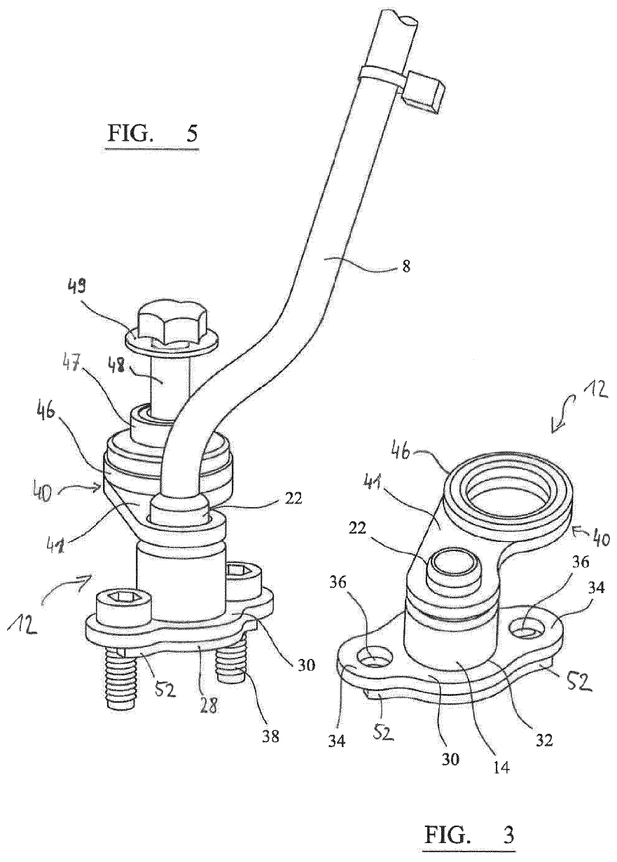

Referring now to FIG. 1, there is schematically shown in outline the cylinder head of a four-cylinder gasoline internal combustion engine 2 having direct injection in which output nozzles 4 of the fuel injectors 6 are located in the combustion chamber of each cylinder. The injectors 6 are each connected to a common rail 10 fuel supply by an associated fuel pipe 8. The common rail 10 is supplied with fuel at a high pressure by a pump (not shown). “High pressure” is in particular a pressure of 50 bar or more, for example between 50 bar and 500 bar, e.g. between 100 bar and 350 bar, the limits being included in each case. The injectors 6 are connected to the pipe 8 by means of an injector cup assembly 12 described in greater detail with reference to FIGS. 2-5.

Referring now to FIGS. 2-6, there is shown in FIG. 2 an injector cup 14 formed as a one-piece body from a sheet of material such as stainless steel by a deep drawing process or pressing technique. As shown particularly in FIG. 4, the injector cup 14 has an axis 16 and is essentially cylindrically formed about its axis 16. The cup 14 has a main body part 18 containing a volume 20 adapted to receive the fuel inlet end of a fuel injector 6. At its outer upstream end, as shown in the drawings, the cup has a coaxial tubular stub 22 having a reduced outer diameter relative to the diameter of the main body part 18 to provide an annular shoulder 24.

The stub 22 contains a fuel inlet port 26 to which the fluid pipe 8 is connected to provide a hydraulic connection between the volume 20 and the common rail 10. At its end opposite the stub 22, the cup 14 is open to receive the inlet end of a fuel injector and has a radially outwardly extending the flange 28. As shown in the bottom view of FIG. 6 on the downstream end of the fuel injector cup 14, the flange 28 has opposed outwardly extending webs 52 each containing a recess 54.

Referring now to FIGS. 2, 3, and 5 in particular, there are in FIG. 2 the components required to secure the injector cup 14 to the injector 6 and to secure the injector cup 14 to the cylinder head 2. The components are a fastening bracket 30 and a clamping arm 40. These components, together with the fuel injector cup 14, constitute the fuel injector cup assembly 12.

The cup 14 is secured to the fuel injector 6 by means of the fastening bracket 30 which consists of a planar body—i.e. the fastening bracket 30 is in particular in the shape of a flat plate—having a central bore 32 and two opposed webs 34 each containing an opening 36 for a bolt 38, as shown in FIG. 5. The diameter of the central bore 32 is such that the bracket 30 is a close sliding fit on the main body part 18 so that it can slide down to abut the flange 28. The bolts 38 serve to secure the bracket 30 to a fuel injector thereby to clamp the cup 14 to the fuel injector 6, as shown in FIG. 1. To ease and speed assembly, the bracket 30 is spot welded and/or brazed to the cup in a position in which the fastening bolts are correctly aligned with threaded bores in the injector assembly. When the fuel injector cup assembly is assembled, the recesses 54 of the opposed outwardly extending webs 52 of the flange 28 of the cup 14 align with the openings 36 in the fastening bracket 30. The webs assist in reducing the deflection of the bracket 30 when the bolts are tightened.

The injector cup 14 can be rigidly fixed to the cylinder head 2 by means of the clamping arm 40. The clamping arm 40 consists of a plate element 41 and a reinforcement ring 46, both of which are metal parts. At least the plate element 41 is preferably a sheet metal part.

Adjacent one of its ends flat plate element 41 has a bore 42 which is dimensioned to be a close sliding fit over the stub 22 so that it slides down to abut the shoulder 24. The other end of the plate element 41 has an opening 44 through which a bolt 48 can pass to secure the clamping arm 40 to the cylinder head 2 and hence clamp the injector cup 14 to the cylinder head 2 of the engine.

The reinforcement ring 46 is fixed to a main face of the plate element 41 so that it surrounds the opening 44 for the bolt 48. The ring 46 is laterally spaced apart from the bore 42 so that a portion of said main face is exposed. In top view on the main face, the ring 46 and the plate element 41 may be flush on a side remote from the bore 42, for example over a circumferential extension of at least 180° of the reinforcement ring 46 with respect to a central axis of the opening 44.

When preparing the components for assembly, the reinforcement ring may be welded to the plate element 41. Preferably subsequently, the clamping arm 40 is spot welded to the cup 14 in the correct position for final assembly, enabling easier and faster assembly to the engine. Subsequent to the respective welding operation, a brazed connection may also be established between the plate element 41 and the reinforcement ring 36 and/or between the clamping arm 40 and the cup 14.

The fuel injector assembly according to the present embodiment further comprises a bolt retainer 47. The bolt retainer 47 consists of plastic and rubber. It is inserted into the opening of the ring 46 and the opening 44 of the plate element 41 and secured to these two parts by means of friction-fit and/or form fit. The bolt retainer 47 projects from the clamping arm 40 in axial direction away from the flange 28 of the fuel injector cup 14 and towards a head of the bolt 48.

The bolt 48 extends in axial direction through the bolt retainer 47 and is secured thereto by friction fit, for example. A washer 49 is positioned axially between the head of the bolt 48 and the bolt retainer 47. When the fuel injector assembly 12 is clamped to the cylinder head 2 with the bolt 48, the washer 49 is clamped between the head of the bolt 48 and the bolt retainer 47.

By means of the bolt retainer 47, vibration damping is achievable between the fuel rail assembly 12 and the cylinder head 2. In addition, by securing the injector to the cup 14 and then securing the cup 14 to the cylinder head 2, there is no direct mechanical connection between the injector itself and the cylinder head 2. It is believed that this configuration may assist in noise reduction as the noise of injection is not transmitted directly to the cylinder head 2.

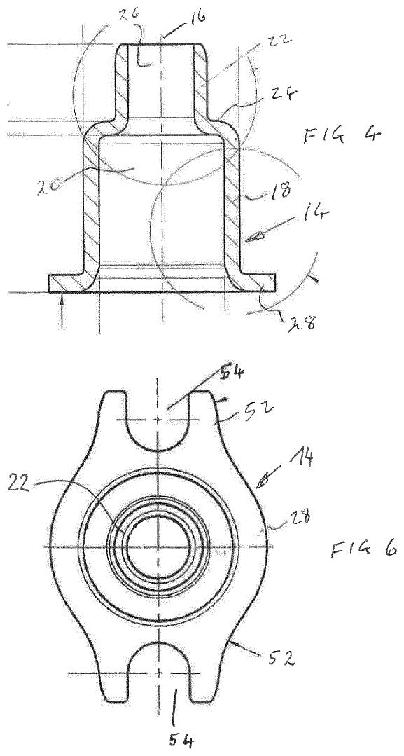

Referring now to FIGS. 7-12, there are shown alternative arrangements for securing the pipe 8 to the stub 22 of the injector cup 14. It will be appreciated that in some installations before the pipe 8 can be secured to the injector cup 14, the fastening bracket 30 and the clamping arm 40 must be positioned on the injector cup 14. In the embodiments shown in the longitudinal section views of FIGS. 7-11, the inlet end of the fuel injector 6 is only shown as a schematic outline representation. The rubber sealing ring and a backup ring which seal the radial gap between the fuel injector cup 14 and the fuel injector 6 are shown oversized to represent the press-fit connection between the rubber sealing ring and the backup ring, respectively, being radially compressed between the injector 6 and the cup 14.

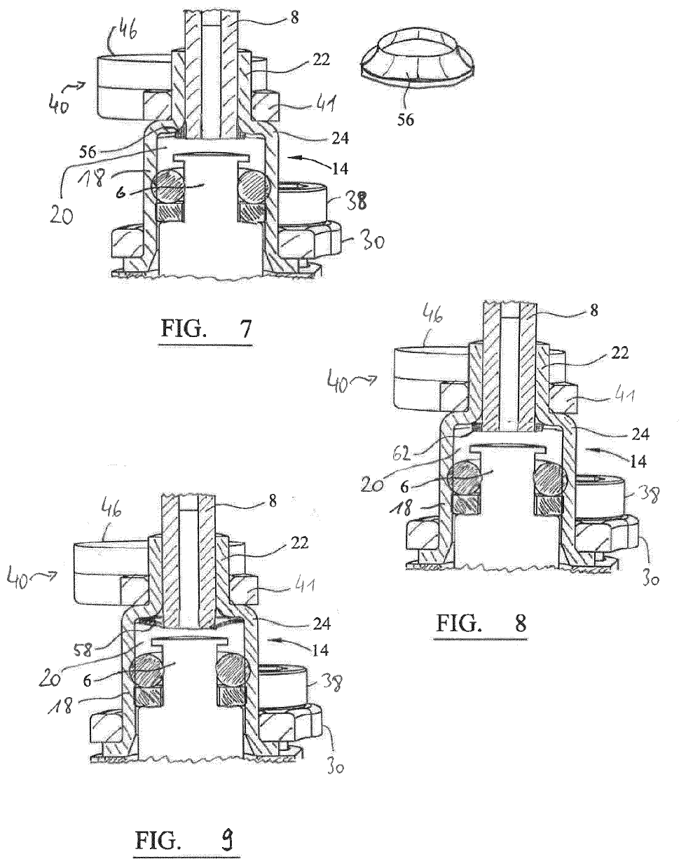

Typically, the pipe 8 is secured to the injector cup 14 by means of brazing or hard soldering. This has the potential problem that molten brazing foil may work its way down into the volume 20 through any gaps which might be between the outer diameter of the pipe 8 and the inner surface of the inlet port 26. In the embodiment shown in a longitudinal section view in the left part of FIG. 7, the pipe 8 extends slightly into the volume 20 in the main body 18. A sealing ring 56—shown separately in a perspective view in the right portion of FIG. 7—is pressed onto the outside of the end of the pipe 8. The cross-sectional profile of the sealing ring 56 is shaped to match the curve in the cup profile where the stub 22 merges into the larger diameter of the main body part 18. This embodiment realizes a particularly large contact area between the sealing ring 56 and the cup 14 to minimize the risk that molten brazing material enters into the interior volume 20 of the cup 20. FIG. 8 shows an arrangement in which a ring 62 of uniform cross-section is positioned between the outer end of the pipe 8 and the curved wall of the main body part 18 to close the gap between the main body part 18 and the outer surface of the pipe 8. In the embodiment shown in FIG. 9, a Belleville washer 58 is pressed onto the end of the pipe to close the space between the Belleville washer 58 and the curved wall of the main body part 18. In both embodiments, a circumferential edge of the ring 62 or the Belleville washer 58, respectively, contacts the cup 14 to separate a receptacle space for molten brazing material from the interior volume 20 of the cup 14. The receptacle space is defined by an upstream surface of the ring 62 or the Belleville washer 58, respectively, together with an outer circumferential surface of the pipe 8 and an inner circumferential surface of the cup 14 where the stub 22 merges into the larger diameter of the main body part 18. These configurations may be particularly insensitive to mounting tolerances.

In some embodiments, the inner circumferential edge of the Belleville washer 58 is axially offset away from the stub 22 towards the flange 28 of the cup 14 with respect to the outer circumferential edge of the Belleville washer 58. In this way, the receptacle space may have a trough shape biasing molten brazing material in radial inward direction. The risk for brazing material entering the volume 20 may, thus, be particularly small.

FIG. 10 shows an embodiment in which an annular disc 60 is secured to the end of the pipe 8. As shown, the disc 60 is generally saucer-shaped, i.e. in particular it extends in curved fashion from its inner circumferential edge where it contacts the pipe 8 to its outer circumferential edge which contacts the inner surface of the cup 18 in a region where the larger diameter of the cup 14 is reduced to that of the stub 22 to thereby close the gap between the pipe 8 and the cup 14. The outer circumferential edge of the disc 60 is in particularly offset in radially outward direction with respect to an outer circumferential surface of the stub 22. While the curvature may be decreasing in radial outward direction in case of the Belleville spring 58 of the previous embodiment, the curvature is increasing in radial outward direction in case of the saucer-shaped annular disc 60 of the present embodiment.

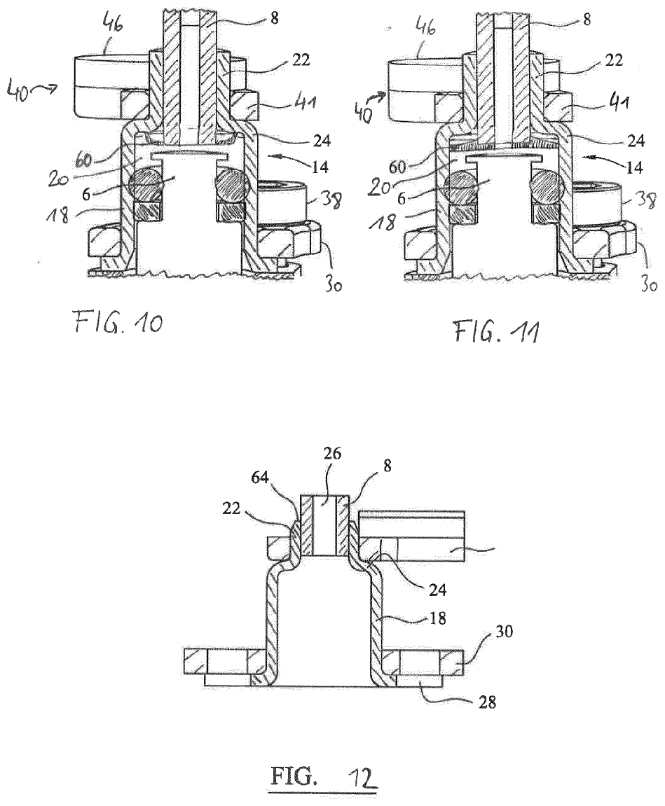

In the embodiment shown in the longitudinal section view of FIG. 11, the end of the pipe 8 which is arranged in the cup 14 is axially offset in upstream direction with respect to the annular disc 60, in contrast to the previous embodiments. In the present embodiment, the end of the pipe 8 is positioned in a recess of the disc 60. Also in contrast to the previous embodiments, the annular disc 60 is in contact with the cylindrical sidewall of the main body part 18 to seal the receptacle area for molten brazing material, downstream of the region of the cup 14 where the larger diameter of the cup 14 is reduced to that of the stub 22.

FIG. 12 shows an example embodiment in which the pipe is welded to the stub 22 about a weld line 64 where the pipe enters the stub 22. The greater strength of a welded joint enables the length of the stub 22 and the amount by which the pipe extends into the inlet port 26 to be reduced. This reduces the length of the stub 22 with a consequent saving in weight and material.

What is claimed is:

1. A fuel injector cup assembly comprising:
a fuel injector cup;
a fastening bracket for securing a fuel injector to the fuel injector cup; and
a clamping arm for fastening the fuel injector cup to an engine;
the fuel injector cup comprising a main body part having an internal volume and adapted to be connected to a fuel source and to receive a fuel inlet end of the fuel injector;
wherein the fuel injector cup comprises a one-piece body defining the main body part and an inlet stub containing a fuel inlet port hydraulically connectable to the fuel source;
the stub having a first external dimension;
the main body part having a second external dimension larger than the first external dimension to provide a shoulder supporting the clamping arm; and
an end of the cup remote from the stub having an outwardly extending flange supporting the fastening bracket.

2. A fuel injector cup assembly according to claim 1, wherein the cup consists of a one-piece body formed from a sheet material.

3. A fuel injector cup assembly according to claim 1, wherein the fastening bracket and the clamping arm are welded or brazed to the cup.

4. A fuel injector cup assembly according to claim 1, wherein:
the fastening bracket defines a central bore dimensioned to fit over the main body part so as to sit on the flange;
the bracket includes two outwardly extending webs each defining an opening receive a fastening element of the fuel injector assembly by means of which the cup and the fuel injector are secured together.

5. A fuel injector cup assembly according to claim 4, wherein the openings in the webs each comprise a bore adapted to receive a bolt.

6. A fuel injector cup assembly according to claim 5, wherein the flange includes outwardly extending opposed webs, each having a recess extending inwardly from the outer edge of the web, the recesses aligning with the openings for the bolts.

7. A fuel injector cup assembly according to claim 1, wherein the clamping arm has at one end a first opening to fit over the stub so as to rest on the shoulder, and at another end of the arm remote from said one end a second opening through which a securing element is able to fasten the clamping arm to the engine to thereby clamp the assembly to the engine.

8. A fuel injector assembly comprising:
a fuel injector cup;
a fastening bracket for securing a fuel injector to the fuel injector cup; and
a clamping arm for fastening the fuel injector cup to an engine;
the fuel injector cup comprising a main body part having an internal volume and adapted to be connected to a fuel source and to receive a fuel inlet end of the fuel injector;
wherein the fuel injector cup comprises a one-piece body defining the main body part and an inlet stub containing a fuel inlet port hydraulically connectable to the fuel source;
the stub having a first external dimension;
the main body part having a second external dimension larger than the first external dimension to provide a shoulder supporting the clamping arm;
an end of the cup remote from the stub having an outwardly extending flange supporting the fastening bracket;
wherein the stub is brazed or welded to a fuel pipe connected hydraulically and mechanically to the fuel source.

9. A fuel injector assembly according to claim 8, wherein a first end of the fuel pipe fits within the fuel inlet port.

10. A fuel injector assembly according to claim 9, further comprising a closure device secured to an outer end of the fuel pipe in the fuel inlet port to close any gap between the fuel pipe and an inner surface of the fuel inlet port to prevent brazing or welding material entering the volume.

11. A fuel injector assembly according to claim 10, wherein the closure device comprises at least one element selected from the group consisting of: a ring, a Belleville washer, and an outwardly extending flange secured to the pipe.

12. A method of producing a fuel injector cup assembly, the method comprising:
forming a main body part and an inlet stub of an injector cup, the main body part defining an internal volume and the stub containing a fuel delivery port for connecting the internal volume to a fuel source, the internal volume configured for receiving an inlet end of a fuel injector to provide a hydraulic communication between an inlet end of the fuel injector and the fuel source;
forming the stub with a first external dimension smaller than a second external dimension of the main body part to form a shoulder;
locating a clamping arm on the shoulder for fastening the cup to an engine;
providing an outwardly extending flange on the cup at a first end remote from the stub; and
locating a fastening bracket on the flange for securing the fuel injector to the cup, wherein the fastening bracket includes outwardly extending webs with openings adapted to receive a fastening element to secure the cup and the injector together.

13. A method according to claim 12, wherein forming an injector cup comprises forming the cup as a one-piece body from a sheet material by deep drawing and/or by a pressing technique.

14. A method according to claim 12, further comprising spot welding the fastening bracket and/or the clamping arm to the cup.

15. A method according to claim 12, wherein the stub has an external diameter, the main body part of the cup being cylindrically formed with an external diameter larger than the diameter of the stub to provide the shoulder, forming an annular shape for the shoulder.
